(19) United States
(12) Patent Application Publication
(10) Pub. No.: US 2008/0250478 A1
(43) Pub. Date: Oct. 9, 2008

(54) Wireless Public Network Access

(76) Inventors: Steven M. Miller, Cary, NC (US); Sudhakar Nagarajan, Cary, NC (US); Mark E. Peters, Chapel Hill, NC (US)

Correspondence Address: MARCIA L. DOUBET LAW FIRM, PO BOX 422859, KISSIMMEE, FL, 34742, US

(21) Appl. No.: 11/697,057

(22) Filed: Apr. 5, 2007

(51) Int. Cl. H04L 9/32

(52) U.S. Cl. 726/5

(57) ABSTRACT

Public access to a network is provided through wireless access points, which may simultaneously support secured network access; in preferred embodiments, the access points are routers (such as “WiFi” routers). Accordingly, a router is configured with a public access profile (or profiles), which may be selectively enabled or disabled. When enabled, the router sends out an identifier that can be used to associate a client device with a public (i.e., unauthenticated) access path through the router to a network. The router also sends out a conventional identifier that can be used to associate another client device with a secured (i.e., authenticated) access path through the router, where the public and secured access paths are usable simultaneously by clients of the router.

### BACKGROUND OF THE INVENTION

The present invention relates generally to computer networks, and more particularly to techniques for providing wireless access to computer networks.

“WiFi” (for “wireless fidelity”) or “Wi-Fi”® is a label commonly applied to devices and networks that follow the Institute of Electrical and Electronics Engineers (“IEEE”) 802.11 specification for wireless network access. The label “WiFi” currently encompasses several different 802.11 specifications, including 802.11a, 802.11b, 802.11g, and 802.11n. An industry interoperability group known as the Wireless Ethernet Compatibility Alliance, Inc. (“WECA”), which is also known as the Wi-Fi Alliance, certifies products as being compliant with WiFi specifications. (“Wi-Fi” is a registered trademark of Wireless Ethernet Compatibility Alliance, Inc.)

WiFi has become very popular among businesses and consumers as an alternative to a wired network configuration. Depending on which 802.11 specification a device adheres to, WiFi technology allows a raw wireless data transmission rate of approximately 11 to 108 megabits per second at indoor distances from several dozen to several hundred feet, and outdoor distances of several miles to tens of miles. Devices conforming to 802.11b, 802.11g, and 802.11n operate using the 2.4 or 2.5 gigahertz band, and devices conforming to 802.11a use one of several frequencies in the 5 gigahertz range.

### BRIEF SUMMARY OF THE INVENTION

In one aspect, an embodiment of the present invention provides wireless access to a computer network, comprising: specifying, for a wireless access point (“WAP”), a public access profile; adapting the WAP to selectively enable or disable the public access profile; transmitting, from the WAP, a public access identifier representing a public access path through the WAP to the computer network if the public access profile is enabled; and transmitting, from the WAP, an authenticated access identifier representing an authenticated access path through the WAP to the computer network if the WAP is enabled for the authenticated access path. (In one alternative aspect, the specifying specifies a plurality of public access profiles for the WAP; the adapting selectively enables or disables each of the public access profiles; and the transmitting of the public access identifier comprises transmitting a public access identifier representing a public access path through the WAP to the computer network for each of the public access profiles that is enabled.) The WAP may be a wireless router, such as a WiFi router, and the authenticated access identifier may be a service set identifier (“SSID”) of the router. This aspect may further comprise: accepting, by the WAP, at least one incoming client connection to the authenticated access identifier upon successfully authenticating a client device from which a connection request is received that requests the incoming client connection, thereby providing the authenticated access path to the client device; and accepting, by the WAP, at least one second incoming client connection to the public access identifier upon receiving a second connection request from a second client device that requests the second incoming client connection, thereby providing the public access path to the second client device. The public access path and the authenticated access path may be simultaneously provided by the WAP. In this and other aspects, the WAP may optionally restrict access to services provided by the WAP, for a guest client device that connects to the WAP using the public access identifier, and not restrict access to the services for an authenticated client device that connects to the WAP using the authenticated access identifier.

In another aspect, an embodiment of the present invention provides public access to a network through a wireless router, comprising: a public access profile specifying a public access identifier representing a public access path through the router to the network; an authenticated access identifier representing an authenticated access path through the router to the network; a configurator for configuring the router to selectively enable or disable the public access profile; a transmitter for transmitting, from the router, the public access identifier if the public access profile is enabled and for transmitting, from the router, the authenticated access identifier if the router is enabled for the authenticated access path; a public access granter for granting public access using the public access path through the router to the network responsive to receiving, at the router from a first client device, a first connection request that requests a first connection to the public access identifier; and an authenticated access granter for granting authenticated access using the authenticated access path through the router to the network responsive to receiving, at the router from a second client device, a second connection request that requests a second connection to the authenticated access identifier and that specifies an authentication key used by the router for authenticating access to the authenticated access path.

In yet another aspect, an embodiment of the present invention provides public access to a network through a WAP, comprising: selectively enabling or disabling a public access profile of the WAP; transmitting, from the WAP, a public access identifier representing a public access path through the WAP to the network if the public access profile is enabled; transmitting, from the WAP, an authenticated access identifier representing an authenticated access path through the WAP to the network if the WAP is enabled for the authenticated access path; and simultaneously providing, by the WAP, the public access path to at least one first client device and the authenticated access path to at least one second client device, responsive to receiving a connection request from each of the first client devices to the public access identifier and to receiving a connection request from each of the second client devices to the authenticated access identifier along with an authentication key that properly authenticates each of the second client devices to the WAP.

These aspects may be provided as methods, systems, and/or computer program products.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined by the appended claims, will become apparent in the non-limiting detailed description set forth below.

The present invention will be described with reference to the following drawings, in which like reference numbers denote the same element throughout.

### BRIEF DESCRIPTION OF THE SEVERAL VIEWS OF THE DRAWINGS

FIG. 1 depicts devices in a simple wireless network configuration, according to the prior art;

FIGS. 2 and 4 illustrate a WiFi client accessing a network using a WiFi router, according to the prior art;

FIG. 3 depicts a sample user interface that shows an entry for each router detected by a client device, enabling a user of the client device to make a selection from among these routers, according to the prior art;

FIG. 5 shows a sample user interface that may be used for configuring a router, according to an embodiment of the present invention, and FIG. 9 shows an alternative sample user interface that may be used, according to a different embodiment;

FIG. 6 provides a flowchart depicting logic with which unauthenticated, or “guest”, clients may be supported by a router that simultaneously supports authenticated clients, according to an embodiment of the present invention;

FIG. 7 depicts a sample user interface with entries showing each router detected by a client device, thereby enabling a user of the client device to make a selection from among the displayed entries, according to an embodiment of the present invention;

FIG. 8 provides a diagram that illustrates how both unauthenticated and authenticated client devices may access a network through a single router, according to techniques disclosed herein;

FIG. 10 depicts an apparatus suitable for storing and/or executing program code; and

FIG. 11 depicts a representative networking environment in which one or more embodiments of the present invention may be used.

### DETAILED DESCRIPTION OF THE INVENTION

Embodiments of the present invention are directed toward providing wireless access to networks, and in particular, to networks which are accessible through a WiFi router. A WiFi router is a router that follows one of the IEEE 802.11 WiFi specifications.

WiFi devices are being embraced by everyday people who love the convenience of being mobile. Mass production has made WiFi devices so inexpensive that WiFi is being widely used for networking in many places, replacing the high-cost special wiring of the past and allowing people to easily move their computing workspace on a moment-to-moment whim. In addition to its popularity in small offices and for in-home networks, public places where WiFi access is commonly available include hotels, airports, coffee shops, and so forth. The term “hot spot” is often used to refer to areas that offer public WiFi access.

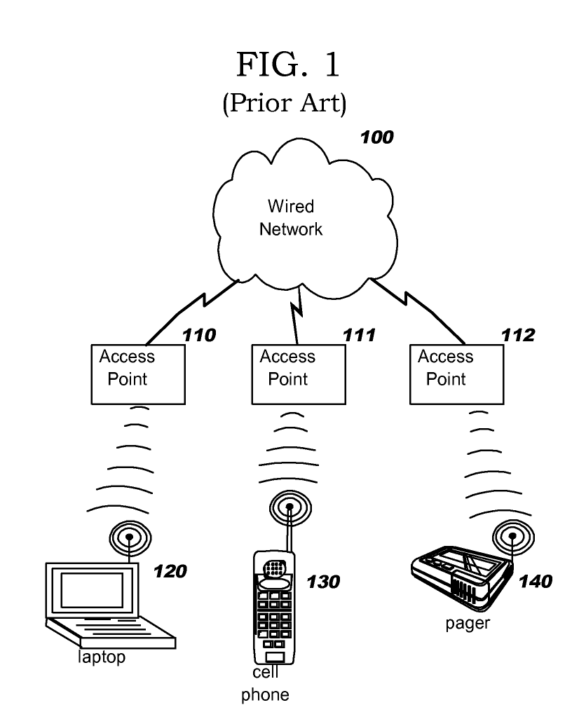

While two modes of WiFi operation are possible, namely peer-to-peer and network, most WiFi installations use the network form where an “access point” serves as a hub that bridges client adapters to one another and to a wired network, often using Network Address Translation (“NAT”) technology. See FIG. 1, where this configuration is illustrated. As shown therein, devices 120, 130, 140 access a wired network 100 through various access points 110-112. WiFi access points may be implemented using wireless routers, which typically also act as firewalls and switches. The term “router” as used herein may be considered synonymous with the term “access point”.

Routers use a routing table (sometimes referred to as a “routing cache”) to route network traffic. The routing table stores information about the path to use in order to route packets (which are also referred to herein as “traffic”) destined for a particular address, as is known in the art. Routers may also filter inbound and/or outbound traffic based on the network address of the sender or receiver. For example, a “deny” filter may be used to specify that traffic destined for a network address specified in this filter is to be denied entry to the network to which the router is connected, and the router will therefore discard any packets matching the specified network address.

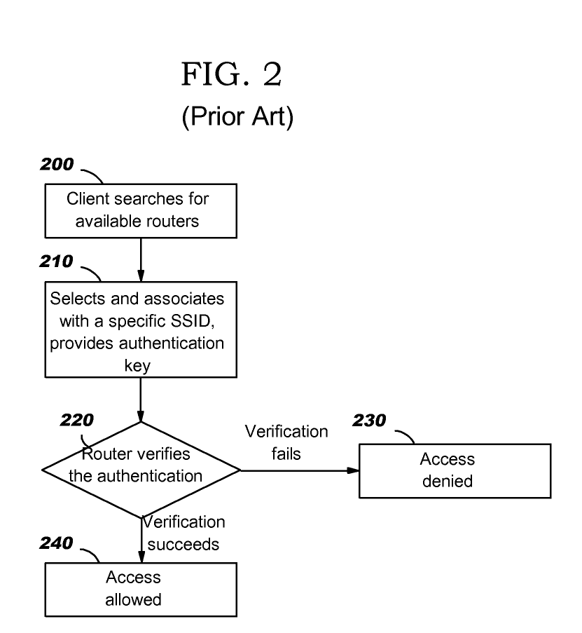

When a WiFi client (i.e., a device that connects to a WiFi network using a built-in WiFi transmitter or an attached WiFi adapter) wants to access a network, it carries out a synchronization protocol that includes several steps which are illustrated in FIG. 2. First, the client searches for available routers (Block 200). The client may either listen for a “beacon” sent periodically by the routers which are near by, or it may send a “probe” and await a response from routers that receive this probe. In either case, the client receives information sent from each router within range of this client, where the received information identifies the router and enables the client to attempt a connection request to that router.

The identifying information sent by the router includes a “service set identifier”, or “SSID”. A default SSID is commonly set by the router manufacturer, and this default value can then be changed (e.g., by a network administrator or by another person, referred to herein as a network administrator for ease of reference) when the router is deployed. Commonly, the SSID is changed to descriptive text that describes the network for which this router provides access. For example, a router might broadcast its SSID as “XYZAirport PublicAccessNetwork” to indicate that it can provide public network access in the “XYZ” airport.

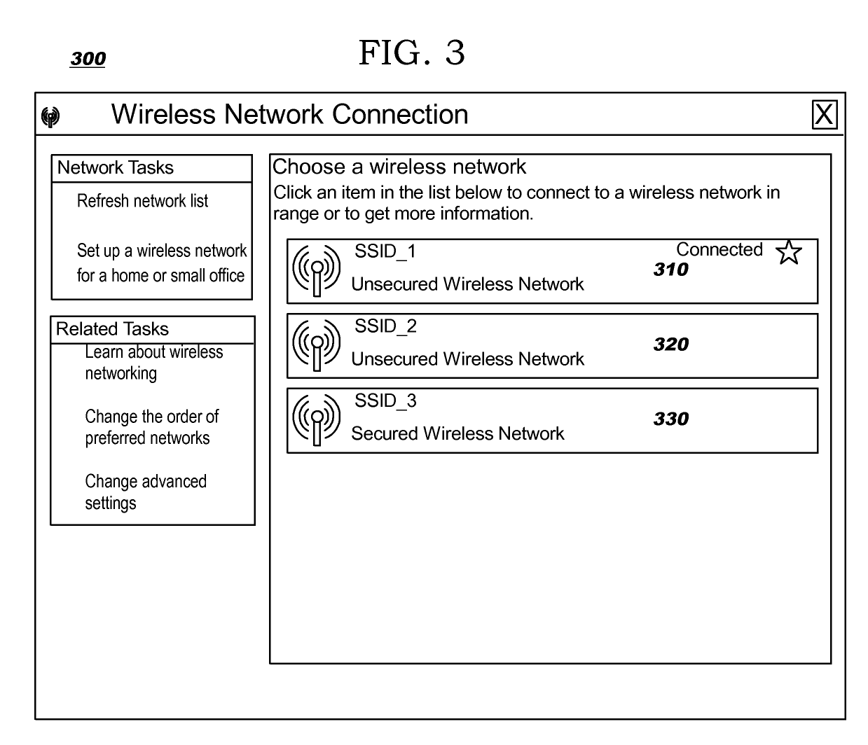

The SSID of each router detected by a client device is typically displayed on a user interface of the client device, enabling a user of the client device to make a selection from among these routers. See FIG. 3, where a sample user interface 300 is depicted. In this example, user interface 300 presents SSID values from 3 routers that are within range of a hypothetical client device; see reference numbers 310-330.

Once the user selects a router associated with a particular SSID, the client device attempts a connection to that router (i.e., to that SSID). This is referred to in FIG. 2 as “associating” with the router. As part of the connection protocol, the client device may be authenticated to the router. WiFi networks generally use one of the following authentication methods: “open-system” authentication; “shared-key” authentication; or “pre-shared-key” authentication (also referred to as “WPA-PSK”). In each of these authentication approaches, the connection request sent from the user's client device (Block 210) to the selected SSID includes an authentication key and specifies an identifier of a particular channel which the router represented by the selected SSID has advertised (i.e., in a beacon or probe response message) as being used by that router to accept incoming messages.

By default, routers are typically sold without an authentication key (e.g., by having the key set to an empty or blank value). In the open-system approach (which is used when the router is not access-protected), this empty/blank key value is transmitted from the client in the connection request, and the router does not perform any actual authentication of the client.

The network administrator can set an authentication key in the router (using, for example, the router's configuration interface) to use one of the secured access approaches (i.e., the shared-key approach or pre-shared-key approach). In this case, client devices that do not provide the proper authentication key value during authentication will be denied access to the network. In the shared-key authentication approach, the client may obtain the authentication key from the router during a challenge message exchange (details of which are not deemed necessary to an understanding of the present invention). In the pre-shared-key approach, the client already has the authentication key, and provides this to the router without requiring a challenge message exchange. (In existing pay-per-use WiFi networks, the authentication key is typically provided to the client upon verifying the client's payment of the proper usage fee.)

Upon receiving the authentication key from the client device, the router performs an authentication process for that client. Block 220 tests whether the authentication is successful. If so, then the client is allowed access (Block 240); as stated above, no actual authentication is performed for open-system authentication, and thus all client devices will successfully complete this open-system authentication process. If the test in Block 220 has a negative result, however (indicating that the client device did not supply the correct authentication key), access to the network through this router is denied (Block 230).

When the authentication succeeds, the client proceeds to an association process which sets up a logical session over which higher-layer protocols and data may flow (not shown in FIG. 2). At any point thereafter, either the router or the client may terminate the association, shutting down further data communications. After the association is terminated, no further data communication can occur until the aforementioned synchronization protocol is repeated to join the network anew.

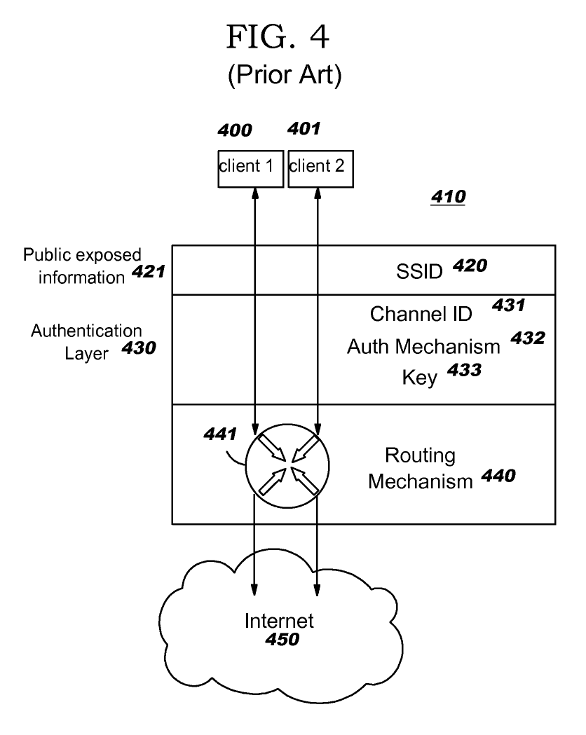

FIG. 4 provides a diagram that illustrates how client devices 400, 401 access a network (which, in this example, is the public internet 450) through a router 410. As shown therein, the router's SSID 420 is exposed to clients 400, 401 as public information of the router 410 (as indicated at 421). Accordingly, the SSID can therefore be displayed to users of client devices on a user interface such as that depicted in FIG. 3 (as discussed above with reference to Block 200 of FIG. 2). The above-discussed authentication process is carried out by an authentication layer 430 of the router. Information used in the authentication process comprises a channel identifier (“ID”) 431, an authentication mechanism 432, and an authentication key 433. The channel ID 431 is commonly used to prevent interference among routers that are located in close proximity to one another. As discussed above, the authentication mechanism 432—which comprises the open-system approach, the shared-key approach, or the pre-shared key approach—indicates what type of authentication is used when authenticating a client device to the router, and the authentication key 433 is used in this process.

The routing mechanism 440 within router 410 consults its routing table to find a path to the destination of the incoming traffic, as represented generally at 441. Assuming client-generated traffic passes the router's filters, the traffic is then forwarded to the network 450. Traffic sent from the network 450 to a client 400, 401 then traverses a return path through the router to that client.

Presently, routers come with capability for a single wireless access configuration. As has been described above, this access configuration can be set to open-system (i.e., unprotected) or, for security-protected networks, can be set to shared-key or pre-shared-key. Using techniques disclosed herein, routers can provide multiple types of access—that is, unprotected access as well as protected access—simultaneously. In one embodiment, routers using techniques disclosed herein come with a separate “public access” configuration or profile (in addition to a protected or secured-access profile), and a network administrator who deploys the router in a network selects whether to enable or disable this public access configuration; when enabled, this configuration provides a public access path through the router. Optionally, an embodiment of the present invention may come with the public access configuration already enabled, by default. (In another embodiment, routers may come with multiple profiles, beyond a single public access profile and a single secured-access profile, and configuring and using a router having multiple profiles is discussed in more detail below with reference to FIG. 9.)

In this manner, WiFi access can be widely supported by leveraging router devices that may be (for example) operating in households throughout a neighborhood, in businesses throughout a business district, and so forth. WiFi devices can therefore operate in any location where such routers are deployed with public access configuration enabled, even though the router may also be using authentication to provide secure access to a network. Using techniques disclosed herein that provide public access through secured-access routers, the public-access coverage can thus be extended without requiring an increase in the number of router devices that are deployed.

As an example of using routers as disclosed herein, so-called “VOIP” (“Voice Over IP”, or “Voice Over Internet Protocol”) telephones have been very popular among consumers, but these VOIP phones require a network connection to support a phone call (and to provide for image reception and transmission, when supported by the VOIP phone). Using existing techniques, users of VOIP phones therefore need to ensure that their phone is within range of a WiFi router or access point; otherwise, the phone cannot be used. By contrast, increasing the number of public-access WiFi routers according to embodiments of the present invention will enable the VOIP phone user to roam over a wide physical area, with an ongoing phone conversation supported as the underlying connection “hops” (i.e., switches) from one WiFi network to another using existing handoff protocols in a manner that is transparent to the phone's user. (These existing handoff protocols occur using techniques which are not deemed necessary to an understanding of the present invention.)

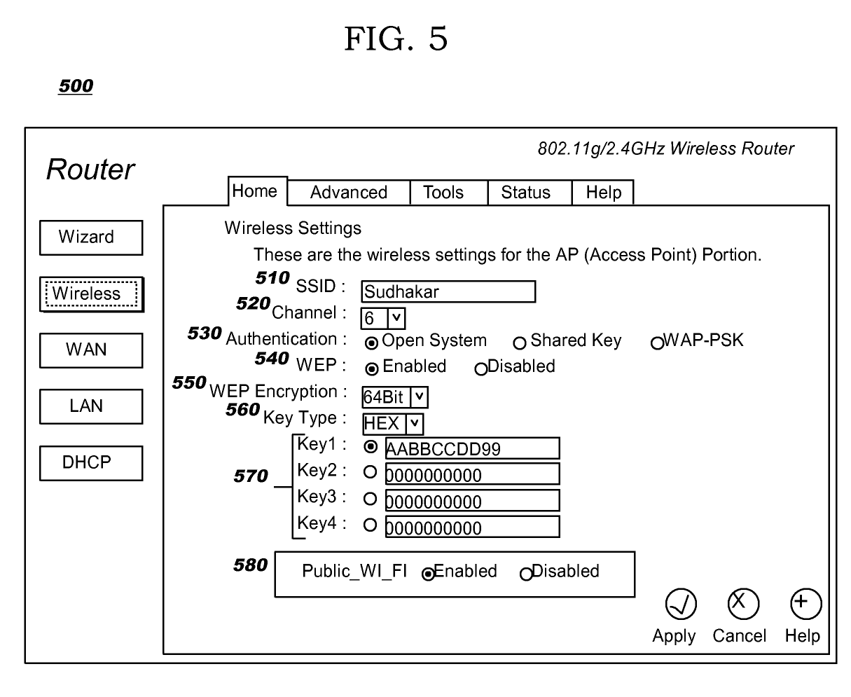

FIG. 5 shows a sample user interface 500 that may be used for configuring a router, according to an embodiment of the present invention. This configuration interface provides for changing the SSID (see 510) and channel (see 520), and for selecting one of the authentication mechanisms (see 530). Encryption may be enabled or disabled using this configuration interface, as shown at 540 (which refers to “WEP”, the Wired Equivalent Privacy encryption algorithm that is built into the 802.11 specification). Any one of 4 authentication keys may be specified from this sample interface, as shown at 570; a drop-down box 560 allows the user to select the encoding in which the keys are specified.

In this sample interface 500, a set of radio button graphics is depicted at 580, and these radio buttons are used to enable or disable a public WiFi access path provided by one embodiment of the present invention. When a public access path is enabled, the router can simultaneously support secured and unsecured access, thus providing one access path for clients that are authenticated and another access path for clients that are not authenticated (respectively), as will now be discussed in more detail.

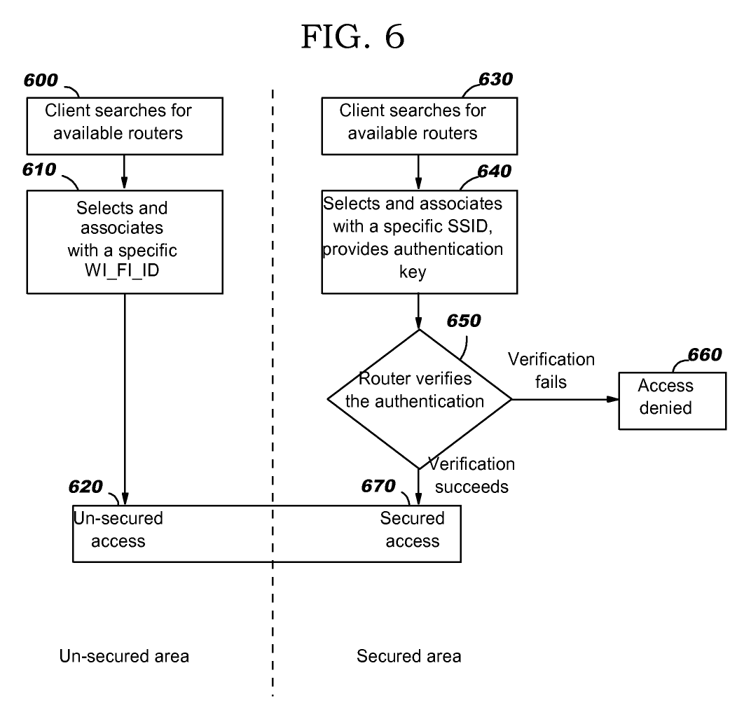

Those clients that access routers using the public access path techniques disclosed herein may be referred to as “guests”. FIG. 6 provides a flowchart depicting logic with which these guest clients may be supported by a router that also supports authenticated clients. As has been discussed above with reference to FIG. 2, the client device searches for available routers. See Block 600, corresponding to a client that will use a public access path, and Block 630, corresponding to a client that will use a secured access path.

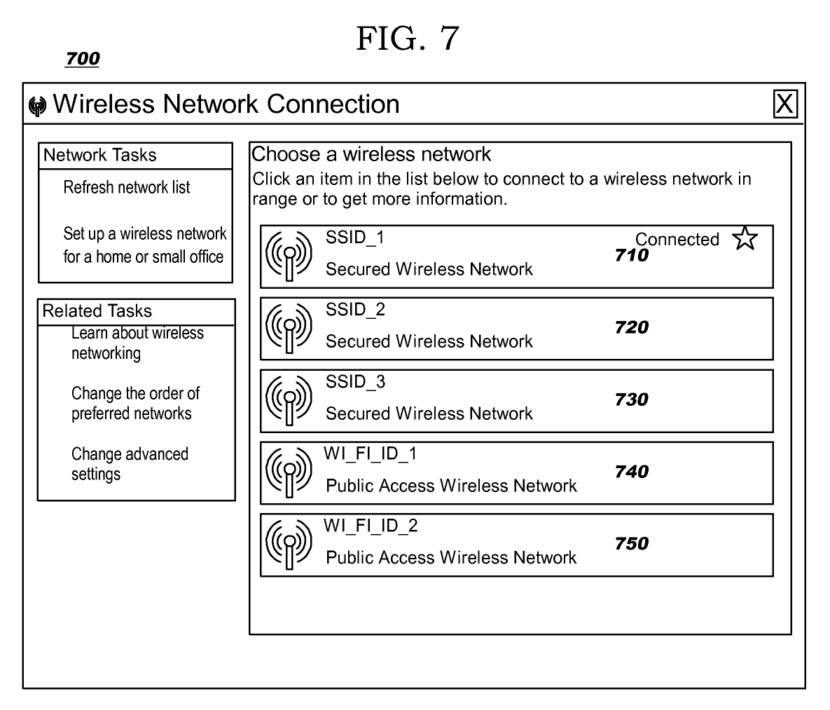

FIG. 7 depicts a sample user interface 700 that may be displayed on the client device in response to the client's search, with entries showing each router detected by the client device, thereby enabling a user of the client device to make a selection from among the displayed entries. Routers according to embodiments of the present invention send an SSID to represent a conventional secured access path (whether in a beacon message or in response to a client's probe request, which were discussed earlier) and in addition, if a public access path is enabled for a particular router, the router also sends an identifier which is referred to herein as a “WI_FI_ID” that represents this public access path. (It should be noted that, in preferred embodiments, the WI_FI_ID identifier(s) corresponding to a particular router may appear to clients as just another SSID, and the distinction between an SSID and a WI_FI_ID may therefore be transparent to the client; the term “WI_FI_ID” is used separately from “SSID” herein for purposes of emphasizing techniques of the present invention.) Accordingly, one physical router may appear to a client as two or more distinct available access paths (and will thus be represented by two or more distinct entries on user interface 700). This is illustrated in FIG. 7, where sample user interface 700 shows a list comprising the SSID values (see entries 710-730) and the WI_FI_ID values (see entries 740 and 750) received from the routers that are in range of a hypothetical client device. In this example, 3 SSID values are displayed but only 2 WI_FI_ID values are displayed. This may indicate, for example, that 3 different routers are in range of the client device and thus provided their SSIDS values, but that 1 of the 3 routers that provided SSID values did not send a WI_FI_ID value because that router does not have a public access path enabled. (Note, however, that in some scenarios, routers might not be represented by an SSID for an authenticated access path in this list 700: if the router provides only public access and does not provide secured access when it sends information to the hypothetical client device, then the router may be represented in list 700 by the WI_FI_ID value associated with each available public access profile of the router.) In the general case, a particular router may be represented on user interface 700 by more than one public identifier value and/or by more than one private identifier value, depending on the router configuration (i.e., depending on the access paths provided by that router).

Preferably, for those routers providing authenticated access paths, the corresponding SSID values are shown in a conventional manner on user interface 700. For those routers that provide a path or paths for guest access, the corresponding WI_FI_ID entry displayed on user interface 700 for each such path may optionally be shown on the available routers list in a visually-distinct manner. For example, highlighting may be placed around the identifiers which are WI_FI_IDs; or, a special graphical symbol may be shown in association with the WI_FI_ID value. Techniques are known in the art for visually distinguishing those routers that provide an authenticated access path from those routers that provide an unauthenticated access path (such as displaying a graphic representing a padlock for authenticated-access SSIDs). In one approach, these techniques may be leveraged for the visual distinguishing of the WI_FI_ID entries. In another approach, a convention may be adopted for generating WI_FI_ID values that serves to distinguish these values from traditional SSID values (such as use of a special prefix). Or, the WI_FI_ID values corresponding to public access paths may be presented on the client's user interface in a manner that is visually indistinguishable from the SSID values corresponding to authenticated access paths. Optionally, a feature may be provided on the client's user interface for selectively filtering the displayed choices, whereby the user may choose to see only the public access choices, or to see only the secured-access choices.

The WI_FI_ID value for a particular router may be programmatically generated, in one approach, using parameter values such as the router manufacturer's name and the SSID of the router. So, for example, if the router is manufactured by “XYZ_Router_Co” and the administrator of the router has set the SSID to “JOE_HOME”, then the WI_FI_ID may be set to “XYZ_Router_Co_JOE_HOME”. Other approaches for creating a WI_FI_ID may be used without deviating from the scope of the present invention, including manually creating the WI_FI_ID by the administrator of the router. Optionally, an embodiment of the present invention may be adapted such that the WI_FI_ID for a particular public access profile of a router is not generated until the public access profile is initially enabled. In another approach, the public access profile for a router is used as the router's default profile; in this case, the WI_FI_ID is preferably generated when the router is initialized (and, optionally, the router administrator may disable the public access default profile or set an authenticated access profile as the default). Furthermore, in one approach, a WI_FI_ID value may be considered as simply a publicly-accessible SSID.

Continuing at Block 610, when the user of a client that will access a public network as a guest picks a public access path represented by a particular WI_FI_ID value from user interface 700, the client device then associates itself with the corresponding router using the selected WI_FI_ID value. In one approach to guest access, as shown in FIG. 6, the client then sends a connection request to the router, where that connection request has no authentication key; the authentication process in the router is therefore bypassed, and the router grants un-secured access rights to this guest (Block 620).

For a client that will authenticate to the router, Block 630 indicates that this client also searches for available routers. A user interface such as 700 of FIG. 7 is preferably shown to the client's user in response to this search, as discussed above with regard to Block 600. Upon the user selecting one of the authenticated access paths represented by a particular SSID value, the client associates with that SSID and the corresponding authentication key (which, as discussed above with reference to Block 210 of FIG. 2, is either obtained using a challenge exchange or is previously known to the client) is sent with the client's connection request to the router, as indicated in Block 640. As indicated by Block 650, the router verifies the authentication key, and if this verification is successful, control transfers to Block 670 which indicates that the router grants secured access rights to this client. If the verification fails, on the other hand, Block 660 indicates that the client is denied access rights.

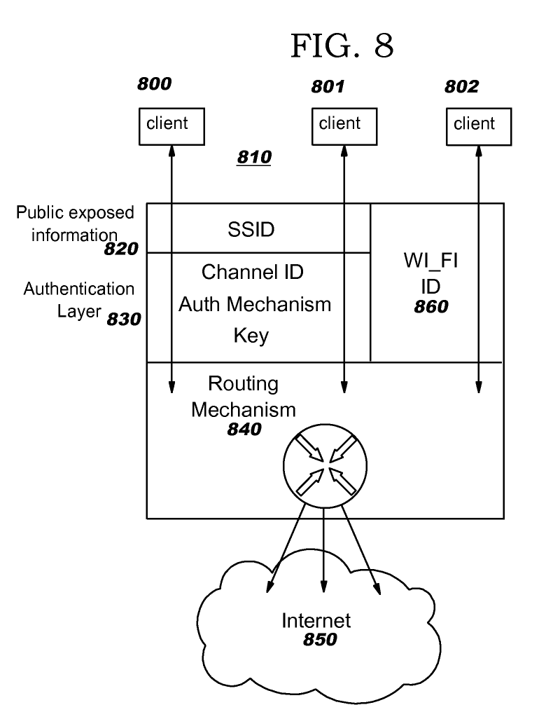

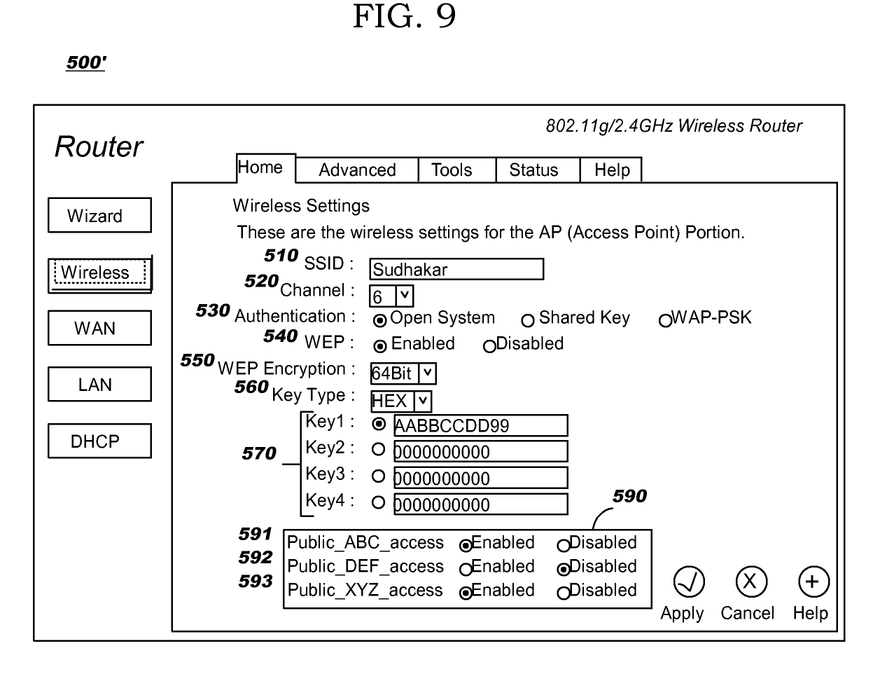

FIG. 8 provides a diagram that illustrates how client devices 800, 801, 802 may access a network (which, in this example, is the public internet 850) through a router 810 according to an embodiment of techniques disclosed herein. As shown in FIG. 8, the SSID 820 is exposed to clients 800, 801 as public information of the router 810. As discussed with reference to FIG. 7, exposing the SSID enables a client device 800, 801 to associate with the corresponding router for authenticated access. The authentication process for clients 800, 801 is carried out by an authentication mechanism of an authentication layer 830, which is preferably analogous to the authentication layer 430 discussed above with reference to FIG. 4.

The WI_FI_ID value corresponding to a router's public access path is also exposed when the client displays a list of available routers to the user, and FIG. 8 depicts guest client 802 associating with router 810 for public access. See 860 of FIG. 8, where the WI_FI_ID for a public access path of router 810 is represented.

Because router 810 does not execute the authentication process for guest client 802, FIG. 8 illustrates that traffic from client 802 bypasses the authentication layer 830.

The routing mechanism 840 within router 810 is preferably similar to routing mechanism 440 of FIG. 4, and routes traffic to and from secured clients 800, 801 as well as traffic to and from unsecured client 802. Accordingly, router 810 consults its routing table to find a path to the destination of the client-generated incoming traffic, and assuming the traffic passes the router's filters, the traffic is then forwarded to the network 850. Traffic sent from the network 850 to a client 800, 801, 802 then traverses a return path through the router to that client.

In an optional aspect, services provided to guests clients may be restricted as compared to services provided to authenticated clients, as will now be described.

In one approach, a bandwidth restriction feature may be implemented that restricts access to bandwidth for guest clients. As one example, available bandwidth may be divided between traffic pertaining to (i.e., received from or sent to) authenticated clients and traffic pertaining to guest clients, where the portion allocated to the guests clients may be significantly less than the portion allocated to the authenticated clients. For example, guest clients might be limited to transmission at a rate of 200 kilobits per second, whereas traffic pertaining to authenticated clients might be transmitted at a rate of several megabits per second, so that the guest clients are not able to take all of the available bandwidth to the disadvantage of the authenticated clients. Router 810 may implement this bandwidth restriction feature (in one approach) by building a list of network addresses corresponding to guest clients, and using the restricted portion of the bandwidth for traffic that pertains to the network addresses on this list.

In another approach, a router priority feature may be implemented whereby authenticated clients receive higher priority than guest clients. For example, traffic pertaining to guest clients may be buffered while the router processes traffic for authenticated clients. A router might use a round-robin scheduling approach to performing path lookups in its routing table, as one example, whereby it iteratively processes path lookups pertaining to 5 authenticated clients and then processes a path lookup for 1 guest client. A quality of service indicator associated with the packets processed by the router may be used, if desired, to determine how to prioritize among the packets to provide this priority handling, whereby the indicator is set higher for authenticated clients than for guest clients.

In yet another approach, a port restriction feature may be implemented that restricts access to ports for guest clients. As one example, VOIP traffic may be assigned to ports 1718, 1719, or 1720 when using Recommendation H.323 (a standard from the ITU Telecommunication Standardization Sector), or to port 5060 when using Session Initiation Protocol (“SIP”). Router 810 may implement this port restriction feature (in one approach) by creating “deny” filters for the guest clients that deny access to any port other than one of the ports used for VOIP traffic. As another example, guest clients may be denied access to other port numbers.

In another optional aspect, encryption may be handled differently for guests clients as compared to encryption for authenticated clients. In one approach, encryption of traffic to and from guest clients is not supported by router 810. In another approach, encryption may be provided to and from the router, thereby providing privacy for traffic sent over this wireless link (but for those client devices which access the router as guest clients, the router will route traffic to the public network but will not route traffic into the private portion of the network).

Authentication keys might be used for differentiating between guest clients and authenticated clients. For example, a client device might be provided with one key that authorizes this client to access the internal or local network connected to that router, whereas a second client device might be provided with a different key that only authorizes this second client to use guest access privileges (that is, to access a public network which is connected to the same router). In one approach, the key that authorizes the authenticated client to access the internal network may be distributed to the client device out of band (i.e., the key is a pre-shared key), and if a key is provided to a guest client, this key may be used (for example) to provide link privacy to a public network. In an alternate embodiment, link privacy could be established to the guest without prior key exchange, for example by using a well-known ad hoc key negotiation protocol such as a Diffie-Hellman key exchange (details of which are not deemed necessary to an understanding of the present invention).

Other types of resource restrictions may also be provided. For example, guest clients and authenticated clients may be restricted to different subsets of the network(s) available by routing through a particular router. In one approach, guest clients are not allowed to access network addresses behind the NAT gateway of the router. Accordingly, authenticated clients may be allowed to access a local-area network or intranet that is connected to the router, in addition to accessing a public network or wide-area network such as the Internet, whereas guest clients can be restricted to accessing only the public or wide-area network. This enables use of an in-home router for public access without exposing the local (i.e., in-home) computing devices to access by guest clients. One way in which this restriction may be implemented is to one network address or address range, or alternatively one network subnet value or values, for use by guest clients and a different address or address range or subnet value(s) for use by authenticated clients. Then, the router either discards or processes the packet, according to its destination address.

Optionally, it may be desirable to implement additional protective measures for a router that supports guest clients. In one approach, a router may track client accesses in order to detect anomalies or attack patterns. If a problem is suspected (for example, upon detecting that a particular guest client is attempting to flood the router with traffic), the router might then disable its public access support (perhaps for a configured time interval such as 15 minutes, or perhaps indefinitely) and might also send a notification to a network administrator, log a message in a repository, and/or take other action. Or, the router may disable public access privileges for one or more client devices (e.g., by detecting the media access control, or “MAC”, address in suspicious packets, and then banning public access to packets based on their MAC address). In another approach, a router might track response times for its clients, and upon detecting that response time for traffic of authenticated clients has dropped below a configurable threshold, the router might then disable its support of guest clients (again, either for a configured time interval, or indefinitely, as desired in a particular implementation). As a further option, it may be desirable to limit the number of associations to a router's public profiles and/or authenticated access profiles, such as ensuring that a maximum number of clients (which may be a configurable value) are associated with public access profiles at a point in time.

Referring now to FIG. 9, a router according to another embodiment of the present invention may be configured with multiple profiles. Sample user interface 500′ is similar to user interface 500 of FIG. 5, but the radio button graphics 500 illustrated therein are now replaced by a set of radio button graphics 590. In this particular example, the router associated with this user interface 500′ is configured with 3 different public access profiles 591-593, and each profile can be enabled or disabled by using its associated radio buttons. In FIG. 9, the profiles 591-593 are shown as having descriptive WI_FI_ID values of “Public_ABC_access”, “Public_DEF_access”, and “Public_XYZ_access”, respectively, to represent each of the public access paths available from this router. The different public access paths may vary, for example, according to which address ranges are available from that access path, or the bandwidth that is allocated to that access path, or the priority assigned to traffic using that access path. A guest client may therefore select from among the WI_FI_ID values according to which access is desired. As another example, the different profiles may represent different authentication types; or, different authentication key values might be used for a single profile, where the different values each represent differing capabilities. As an example of this latter approach, a client that supplies a null key value when using a particular profile might receive guest access privileges, whereas a client that supplies a different authentication key value when using that same profile might receive broader capabilities (such as higher bandwidth) and a client that supplies yet another authentication key value might receive still different capabilities. (Although not shown in FIG. 9, a radio button graphic may be provided on user interface 500′ that can be clicked to indicate whether the keys shown at 570 pertain to authenticated access profiles or to public access profiles.)

Once a router has been configured to enable one or more public access profiles from user interface 500′, it may filter its incoming traffic and provide differentiated services accordingly. (Refer, generally, to the discussion of FIGS. 6 and 8, above; it will be obvious to one of ordinary skill in the art, given the teachings disclosed herein, how these discussions may be adapted in terms of supporting multiple public access profiles.)

As will be appreciated by one of skill in the art, embodiments of the present invention may be provided as (for example) methods, systems, and/or computer program products. The invention can take the form of an entirely hardware embodiment, an entirely software embodiment, or an embodiment containing both hardware and software elements. In a preferred embodiment, the invention is implemented in software, which includes (but is not limited to) firmware, resident software, microcode, etc. Furthermore, the present invention may take the form of a computer program product which is embodied on one or more computer-usable storage media (including, but not limited to, disk storage, CD-ROM, optical storage, and so forth) having computer-usable program code embodied therein, where this computer program product may be used by or in connection with a computer or any instruction execution system For purposes of this description, a computer-usable or computer-readable medium can be any apparatus that can contain, store, communicate, propagate, or transport the program for use by or in connection with the instruction execution system, apparatus, or device.

The medium may be an electronic, magnetic, optical, electromagnetic, infrared, or semiconductor system (or apparatus or device) or a propagation medium Examples of a computer-readable medium include a semiconductor or solid state memory, magnetic tape, a removable computer diskette, a random access memory (“RAM”), a read-only memory (“ROM”), a rigid magnetic disk, and an optical disk. Current examples of optical disks include compact disk read-only memory (“CD-ROM”), compact disk read/write (“CD-R/W”), and DVD.

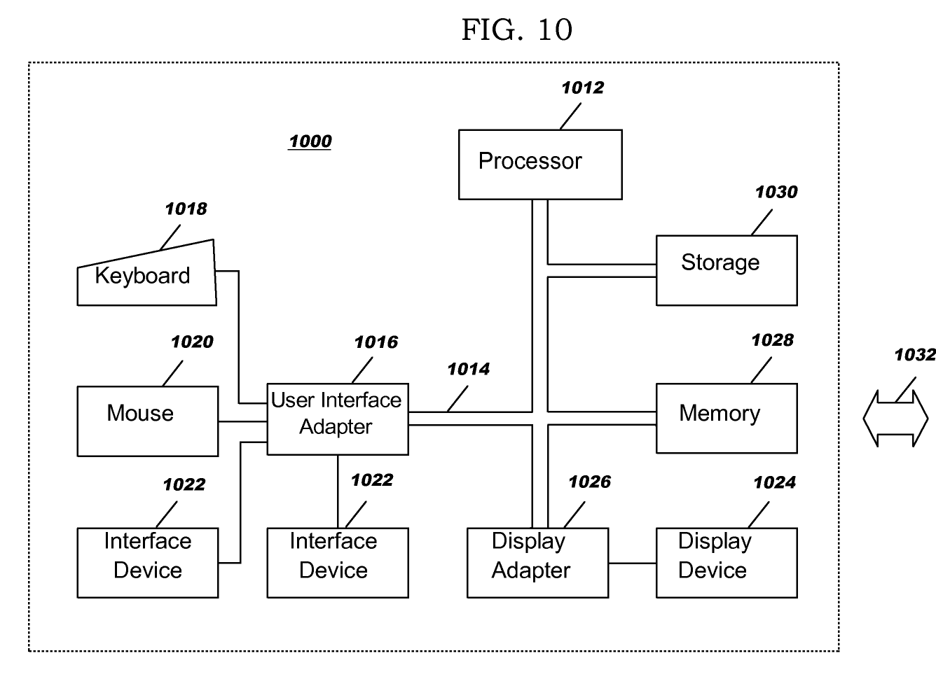

Referring now to FIG. 10, an apparatus 1000 suitable for storing and/or executing program code includes at least one processor 1012 coupled directly or indirectly to memory elements through a system bus 1014. The memory elements can include local memory 1028 employed during actual execution of the program code, bulk storage 1030, and cache memories (not shown) which provide temporary storage of at least some program code in order to reduce the number of times code must be retrieved from bulk storage during execution.

Input/output (“I/O”) devices (including but not limited to keyboards 1018, displays 1024, pointing devices 1020, other interface devices 1022, etc.) can be coupled to the apparatus either directly or through intervening I/O controllers or adapters (1016, 1026).

Network adapters coupled to the apparatus enable the apparatus to become communicatively coupled to other devices through intervening private or public networks (as shown generally at 1032). Modems, cable modem attachments, wireless adapters, and Ethernet cards are just a few of the currently-available types of network adapters.

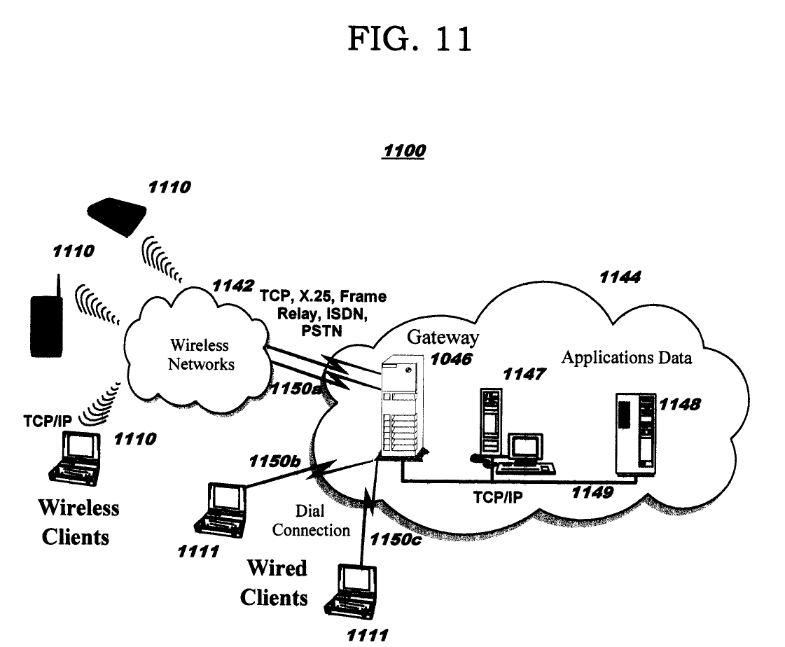

FIG. 11 illustrates a data processing network environment 1100 in which the present invention may be practiced. The data processing network 1100 may include a plurality of individual networks, such as wireless network 1142 and network 1144. A plurality of wireless devices 1110 may communicate over wireless network 1142, and a plurality of wired devices, shown in the figure (by way of illustration) as workstations 1111, may communicate over network 1144. Additionally, as those skilled in the art will appreciate, one or more local area networks (“LANs”) may be included (not shown), where a LAN may comprise a plurality of devices coupled to a host processor.

Still referring to FIG. 11, the networks 1142 and 1144 may also include mainframe computers or servers, such as a gateway computer 1146 or application server 1147 (which may access a data repository 1148). A gateway computer 1146 serves as a point of entry into each network, such as network 1144. The gateway 1146 may be preferably coupled to another network 1142 by means of a communications link 1150a. The gateway 1146 may also be directly coupled to one or more workstations 1111 using a communications link 1150b, 1150c, and/or may be indirectly coupled to such devices. The gateway computer 1146 may be implemented utilizing an Enterprise Systems Architecture/390® computer available from IBM. Depending on the application, a midrange computer, such as an Application System/400® (also known as an AS/400®) may be employed. (“Enterprise Systems Architecture/390”, “Application System/400”, and “AS/400” are registered trademarks of IBM in the United States, other countries, or both.)

The gateway computer 1146 may also be coupled 1149 to a storage device (such as data repository 1148).

Those skilled in the art will appreciate that the gateway computer 1146 may be located a great geographic distance from the network 1142, and similarly, the wireless devices 1110 and/or workstations 1111 may be located some distance from the networks 1142 and 1144, respectively. For example, the network 1142 may be located in California, while the gateway 1146 may be located in Texas, and one or more of the workstations 1111 may be located in Florida. The wireless devices 1110 may connect to the wireless network 1142 using a networking protocol such as the Transmission Control Protocol/Internet Protocol (“TCP/IP”) over a number of alternative connection media, such as cellular phone, radio frequency networks, satellite networks, etc. The wireless network 1142 preferably connects to the gateway 1146 using a network connection 1150a such as TCP or User Datagram Protocol (“UDP”) over IP, X.25, Frame Relay, Integrated Services Digital Network (“ISDN”), Public Switched Telephone Network (“PSTN”), etc. The workstations 1111 may connect directly to the gateway 1146 using dial connections 1150b or 1150c. Further, the wireless network 1142 and network 1144 may connect to one or more other networks (not shown), in an analogous manner to that depicted in FIG. 11.

The present invention has been described with reference to flow diagrams and/or block diagrams according to embodiments of the invention. It will be understood that each flow and/or block of the flow diagrams and/or block diagrams, and combinations of flows and/or blocks in the flow diagrams and/or block diagrams, can be implemented by computer program instructions. These computer program instructions may be provided to a processor of a general purpose computer, special purpose computer, embedded processor, or other programmable data processing apparatus to produce a machine, such that the instructions, which execute via the processor of the computer or other programmable data processing apparatus, create means for implementing the functions specified in the flow diagram flow or flows and/or block diagram block or blocks.

These computer program instructions may also be stored in a computer-readable memory that can direct a computing device or other programmable data processing apparatus to function in a particular manner, such that the instructions stored in the computer-readable memory produce an article of manufacture including instruction means which implement the function specified in the flow diagram flow or flows and/or block diagram block or blocks.

The computer program instructions may also be loaded onto a computing device or other programmable data processing apparatus to cause a series of operational steps to be performed on the computing device or other programmable apparatus to produce a computer-implemented process such that the instructions which execute on the computing device or other programmable apparatus provide steps for implementing the functions specified in the flow diagram flow or flows and/or block diagram block or blocks.

While embodiments of the present invention have been described, additional variations and modifications in those embodiments may occur to those skilled in the art once they learn of the basic inventive concepts. Therefore, it is intended that the appended claims shall be construed to include the described embodiments and all such variations and modifications as fall within the spirit and scope of the invention.

1. A method of providing wireless access to a computer network, comprising:
specifying, for a wireless access point (“WAP”), a public access profile;
adapting the WAP to selectively enable or disable the public access profile;
transmitting, from the WAP, a public access identifier representing a public access path through the WAP to the computer network if the public access profile is enabled; and
transmitting, from the WAP, an authenticated access identifier representing an authenticated access path through the WAP to the computer network if the WAP is enabled for the authenticated access path.

2. The method according to claim 1, further comprising:
restricting access to services provided by the WAP, for a guest client device that connects to the WAP using the public access identifier, and not restricting access to the services for an authenticated client device that connects to the WAP using the authenticated access identifier.

3. The method according to claim 1, wherein the WAP is a WiFi router.

4. The method according to claim 1, further comprising:
accepting, by the WAP, at least one incoming client connection to the authenticated access identifier upon successfully authenticating a client device from which a connection request is received that requests the incoming client connection, thereby providing the authenticated access path to the client device; and
accepting, by the WAP, at least one second incoming client connection to the public access identifier upon receiving a second connection request from a second client device that requests the second incoming client connection, thereby providing the public access path to the second client device.

5. The method according to claim 1, further comprising simultaneously providing, by the WAP, the public access path to at least one first client device and the authenticated access path to at least one second client device, responsive to receiving connection requests from each of the first client devices to the public access identifier and to receiving connection requests from each of the second client devices to the authenticated access identifier along with authentication keys that properly authenticate each of the second client devices to the WAP.

6. The method according to claim 1, wherein the public access identifier is programmatically created by the WAP, responsive to enabling the public access profile.

7. The method according to claim 1, wherein the authenticated access identifier is a service set identifier (“SSID”) that is configured for the WAP.

8. The method according to claim 1, wherein the transmitting of the public access identifier and the transmitting of the authenticated access identifier occurs responsive to receiving, at the WAP, a probe request from a client device.

9. The method according to claim 1, wherein the transmitting of the public access identifier and the transmitting of the authenticated access identifier occurs by sending, from the WAP, a beacon message.

10. The method according to claim 1, further comprising:
displaying, on a user interface of a client device, a list comprising a plurality of identifiers received from at least one WAP that is within communication range of the client device, wherein:
at least one of the displayed identifiers comprises the public access identifier received from a first one of the at least one WAPs that is within communication range and for which the public access profile is enabled; and
at least one of the displayed identifiers comprises the authenticated access identifier received from a second one of the at least one WAPs that is within communication range.

11. The method according to claim 10, further comprising:
selecting, by a user of the client device, one of the displayed identifiers from the list; and
sending a connection request from the client device to the selected identifier, wherein the connection request specifies an authentication key value that is empty if the selected identifier comprises one of the at least one public access identifiers and is non-empty otherwise.

12. The method according to claim 5, wherein at least one of the at least one first client devices is a Voice Over Internet Protocol (“VOIP”) telephone.

13. The method according to claim 1, wherein:
the specifying specifies a plurality of public access profiles for the WAP;
the adapting selectively enables or disables each of the public access profiles; and
the transmitting of the public access identifier comprises transmitting a public access identifier representing a public access path through the WAP to the computer network for each of the public access profiles that is enabled.

14. A system for providing public access to a network through a wireless router, comprising:
a public access profile specifying a public access identifier representing a public access path through the router to the network;
an authenticated access identifier representing an authenticated access path through the router to the network;
a configurator for configuring the router to selectively enable or disable the public access profile;
a transmitter for transmitting, from the router, the public access identifier if the public access profile is enabled and for transmitting, from the router, the authenticated access identifier if the router is enabled for the authenticated access path;
a public access granter for granting public access through the router to the network using the public access path responsive to receiving, at the router from a first client device, a first connection request that requests a first connection to the public access identifier; and
an authenticated access granter for granting authenticated access through the router to the network using the authenticated access path responsive to receiving, at the router from a second client device, a second connection request that requests a second connection to the authenticated access identifier and that specifies an authentication key used by the router for authenticating access to the authenticated access path.

15. The system according to claim 14, wherein the router is a WiFi router.

16. The system according to claim 14, wherein:
the router is enabled for the public access path responsive to configuring the router to selectively enable the public access profile; and
when the public access profile is enabled, the router is simultaneously enabled for the public access path and for the authenticated access path.

17. The system according to claim 14, wherein the first client device is a Voice Over Internet Protocol (“VOIP”) telephone.

18. A computer program product comprising at least one computer-usable media, the media embodying computer-usable program code for providing public access to a network through a wireless access point (“WAP”), wherein the computer program product comprises:
computer-usable program code for selectively enabling or disabling a public access profile of the WAP;
computer-usable program code for transmitting, from the WAP, a public access identifier representing a public access path through the WAP to the network if the public access profile is enabled;
computer-usable program code for transmitting, from the WAP, an authenticated access identifier representing an authenticated access path through the WAP to the network if the WAP is enabled for the authenticated access path; and
computer-usable program code for simultaneously providing, by the WAP, the public access path to at least one first client device and the authenticated access path to at least one second client device, responsive to receiving a connection request from each of the first client devices to the public access identifier and to receiving a connection request from each of the second client devices to the authenticated access identifier along with an authentication key that properly authenticates each of the second client devices to the WAP.

19. The computer program product according to claim 18, wherein the WAP is a WiFi access point.

20. The computer program product according to claim 18, wherein the computer-readable program code for simultaneously providing further comprises:
computer-readable program code for accepting, by the WAP, the connection request received from each of the at least one first client devices, thereby providing the public access path to that first client device; and
computer-readable program code for accepting, by the WAP, the connection request received from each of the at least one second client devices upon successfully authenticating that second client device, thereby providing the authenticated access path to that second client device.

21. The computer program product according to claim 18, wherein the WAP simultaneously transmits the public access identifier and the authenticated access identifier when the public access profile is enabled.
